(19) United States
(12) Patent Application Publication
(10) Pub. No.: US 2021/0069951 A1
(43) Pub. Date: Mar. 11, 2021

(54) Forming Mold

(71) Applicant: Yong Tai Electronic(DONGGUAN) Ltd., Dongguan City (CN)

(72) Inventors: XUE-QIN ZHANG, Dongguan City (CN); MING-XING GUI, Dongguan City (CN); YU-SHENG LI, Dongguan City (CN); SHI-HAI ZHOU, Dongguan City (CN); XU-HUI WANG, Dongguan City (CN)

(21) Appl. No.: 17/007,154

(22) Filed: Aug. 31, 2020

(30) Foreign Application Priority Data
Sep. 5, 2019 (CN) 201910836124.6

(51) Int. Cl. B29C 45/14; B29C 45/26; B29C 45/36

(52) U.S. Cl. CPC B29C 45/14065; B29C 45/2602; B29L 2031/36; B29C 2045/363; B29C 2045/14098; B29C 45/36

(57) ABSTRACT

The invention discloses a forming mold including a stationary half and a moving half matched with the fixed one. The stationary half including a stationary plate, a stationary base fixed on the stationary plate, and a slider and a movable traverse bar which are disposed on the stationary base. The slider and the movable traverse bar are movable on the stationary base in a vertical direction. The moving half is movable relative to the fixed one in a horizontal direction. A space for in-mold forming is created between the two mold modules. By moving the slider and the movable traverse bar in the vertical direction, the forming mold can adapt to different workpieces. The flexibility of the forming mold can be increased, and the cost can be saved by way of not having to change to another sized of forming mold.

### CROSS REFERENCE TO PRIORITY APPLICATIONS

This application claims the benefit of Chinese Application CN201910836124.6 for a forming mold which is filed on Sep. 5, 2019 at the China National Intellectual Property Administration, CNIPA). The disclosure of the above application is incorporated herein by reference.

### FIELD OF THE INVENTION

The invention pertains to a forming mold.

### BACKGROUND OF THE INVENTION

In the related art, a forming mold generally includes two parts: a movable mold and a fixed mold that can be joined or separated. The blank material can be injected into the chamber for forming when the two parts are joined, and the finished workpiece can be removed when the two parts are separated. The connectors nowadays are getting thinner and lighter. Nevertheless, the market still requires sufficient mechanical strength and aesthetic quality while pursuing thinner and lighter connector structures. Therefore, the use of magnesium, aluminum, zinc, and other metal alloys to manufacture low cost, high strength, and high metallic quality casings through die-casting or other process, has become one of the main trends followed by the connector manufacturers.

A known method of in-mold injection is to place a metal workpiece in the injection mold and then a plastic material is injected into the injection mold, so the plastic material and the metal workpiece are formed as one integrated piece. Through the process of in-mold injection, the plastic material and the metal workpiece are tightly bonded. Such bond exhibits high mechanical strength, and the plastic material and the metal workpiece can be integrated seamlessly. The product has high quality appearance and good performance. Therefore, the in-mold injection bonding method is widely used.

Take the connectors as an example. With current development of electronic technology, the connectors have developed into a series and professional product with a complete range of types, various specifications, and diverse structural classes. The in-mold forming process of the metal casing of the connector is one of the manufacturing steps. However, during the production process of the metal casing of the connector, a certain size difference will be produced. When the metal casing is too short, a gap is generated between the metal casing and the mold, and burrs are easily generated during the in-mold forming process. When the metal casing is too long, the metal casing interferes with the mold, and the metal casing would be damaged.

In view of the above-mentioned problem, there exists a need for a new forming mold.

### SUMMARY OF THE INVENTION

To overcome the drawback and insufficiency of the known technology, the invention provides a forming mold which adapts to different workpieces to be processed of different sizes.

The invention discloses a forming mod, including a stationary half and a moving half matched with the stationary half. The stationary half includes a stationary plate, a stationary base fixed on the stationary plate, and a slider and a movable traverse bar which are disposed on the stationary base. The slider and the movable traverse bar are movable on the stationary base in a vertical direction. The moving half is movable relative to the stationary half in a horizontal direction, and a space for in-mold forming is created between the stationary half and the moving half.

The forming mold of the present invention has the following beneficial effects.

The slider and the movable traverse bar of the forming mold are movable on the stationary base in the vertical direction, which can realize the function of adapting to different workpieces to be processed of different sizes. The flexibility of applying the forming mold to different workpieces to be processed can be increased, the quality of the in-mold forming can be improved, and the cost can be reduced.

### BRIEF DESCRIPTION OF THE DRAWINGS

The invention will be described with reference to the accompanying drawings. These and/or other aspects and advantages of the invention will become apparent and more readily appreciated from the following description of the embodiments, taken in conjunction with the accompanying drawings.

FIG. 1 is a partial three-dimensional exploded view of the forming mold according to one embodiment of the present invention.

FIG. 2 is a partial three-dimensional exploded view of the forming mold from another view angle.

FIG. 3 is a three-dimensional schematic diagram of the moving half and the stationary half of the forming mold.

FIG. 4, which is a three-dimensional schematic diagram of the moving half and the stationary half of the forming mold joined with each other according to the embodiment of the invention.

FIG. 5 is a three-dimensional schematic diagram of the slider of the forming mold of the present embodiment of the invention.

FIG. 6 is a three-dimensional schematic diagram of the slider from another view angle.

FIG. 7 is a three-dimensional exploded view of the folding mold.

### DETAILED DESCRIPTION OF THE INVENTION

Reference will now be made in detail to elaborate the technical features for achieving the objects of the embodiments of the present invention with accompanying drawings and embodiments. Those skilled in the art can understand that the directional terms provided in the specific embodiments of the invention, such as up, down, left, right, front, back, vertical, horizontal. . . etc., are only used for elaboration with reference to the direction of the accompanying drawings and are not intended to limit the invention. In addition, a variety of alternations and modifications can be made by those skilled in the art without departing from the spirit and the scope of the invention, and such derived embodiments will also fall within the scope of the invention.

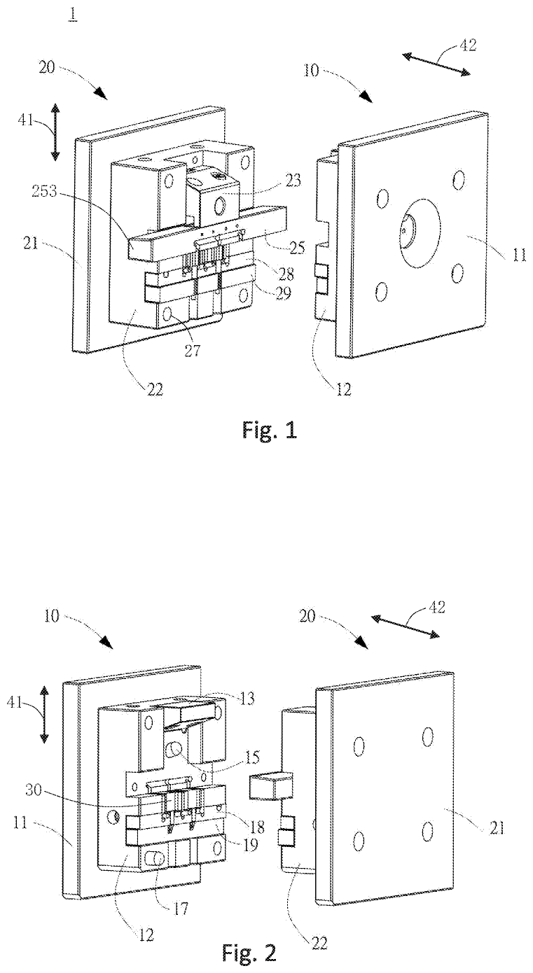

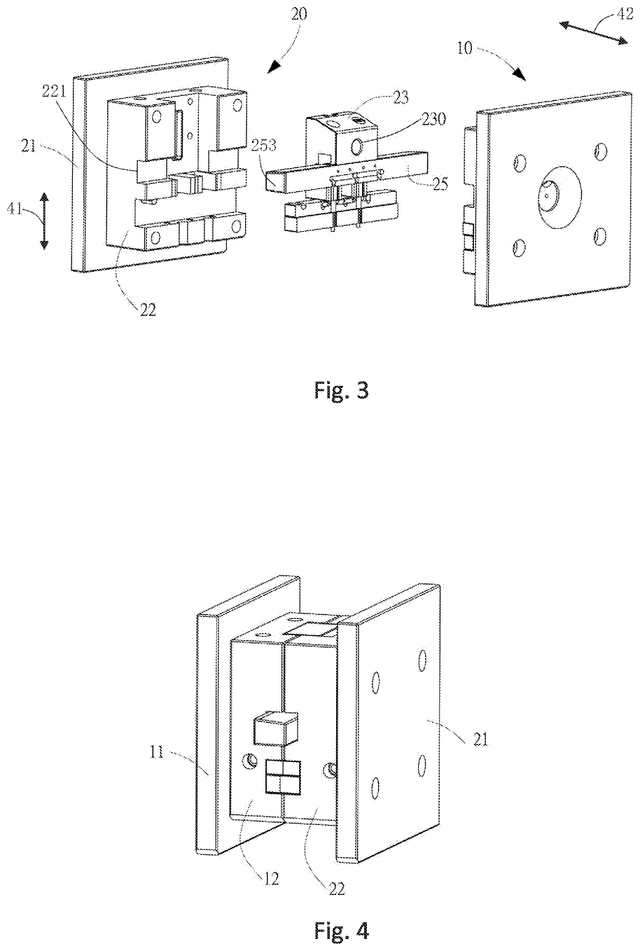

Please refer to FIGS. 1, 2 and 3. FIG. 1 is a partial three-dimensional exploded view of the forming mold according to one embodiment of the present invention. FIG. 2 is a partial three-dimensional exploded view of the forming mold from another view angle. FIG. 3 is a three-dimensional schematic diagram of the moving half and the stationary half of the forming mold.

The forming mold 1 of the present embodiment of the invention is used for in-mold forming of a workpiece to be processed. In the embodiments of the invention, the workpiece to be processed can be exemplified by a cable connector having a connector head, a metal casing, and a cable. A plastic material is injected molded over the metal casing in the forming mold 1 so the plastic material and the metal casing form one integrated piece. However, the workpiece to be processed is not limited to the cable connector in the present invention, other electronic components applicable to the in-mold forming process can be used in the forming mold 1 of the embodiments of the present invention.

The forming mold 1 of the present embodiment includes a stationary half 20 and a moving half 10 that matches with the stationary half 20. The stationary half 20 includes a stationary plate 21, a fix mold base 22 fixed on the stationary plate 21, and a slider 23 and a movable traverse bar 25 which are disposed on the stationary base 22. The slider 23 and the movable traverse bar 25 are movable on the stationary base 22 in a vertical direction 41. In the present embodiment, a horizontal direction 42 is defined as parallel to the closing direction of the forming mold 1. The vertical direction 41 is defined as parallel to the extending direction of the moving half 10 or the stationary half 20. The vertical direction 41 is perpendicular to the horizontal direction 42 and to the ground.

The moving half 10 is movable in relation to the stationary half 20 in the horizontal direction 42. A space 30 is created between the moving half 10 and the stationary half 20 to accommodate the workpiece to be processed. The movable traverse bar 25 which is movable in the vertical direction 41 is used for abutting against the workpiece to be processed. The workpiece to be processed is disposed between the moving half 10 and the stationary half 20 to undergo the in-mold forming process.

The moving half 10 of the present embodiment includes a moving plate 11 and a moving base 12 fixed on the moving plate 11. When the moving base 12 and the stationary base 22 are joined, the workpiece to be processed, the slider 23, and the movable traverse bar 25 are sandwiched therebetween.

The moving base 12 includes a shovel element 13 and an inclined guide pillar 15. When the moving half 10 moves towards the stationary half 20, the shovel element 13 and the inclined guide pillar 15 drive the slider 23 moving towards the workpiece to be processed. As shown in FIG. 2, the shovel element 13 has an ascent surface which inclines upwardly. The entire inclined guide pillar 15 and the ascent surface of the shovel element 13 extend upwardly at the same time, so when the moving half 10 moves towards the stationary half 20 in the horizontal direction 42, the slider 23 is driven by the inclined guide pillar 15 and the shovel element 13 to move downwardly towards the workpiece to be processed in the vertical direction 41.

As shown in FIG. 3, the stationary base 22 has a slot 221 which is used for receiving the movable traverse bar 25. The size of the slot 221 in the vertical direction 41 is larger than the size of the movable traverse bar 25 in the vertical direction 41, so the movable traverse bar 25 is movable in the slot 221 and that the movable traverse bar 25 can be driven by the slider 23 to abut downwardly against the workpiece to be processed in the vertical direction 41. The location where the movable traverse bar 25 abuts against the workpiece to be processed can be changed by adjusting the location of the movable traverse bar 25 in the vertical direction 41. By adjusting the vertical location of the movable traverse bar 25, the forming mold 1 can adapt to different workpieces of different sizes, thus increasing the flexibility of utilizing the forming mold 1.

Please refer to FIG. 4, which is a three-dimensional schematic diagram of the moving half and the stationary half of the forming mold joined with each other according to the embodiment of the invention. The moving half 10 continues to move towards the stationary half 20 in the horizontal direction 42 until they are closely joined with each other. When they are closely joined with each other, the slider 23 abuts against the movable traverse bar 25 in the vertical direction 41, and the movable traverse bar 25 abuts against the workpiece to be processed in the vertical direction 41, so the workpiece to be processed is fixed in the forming mold 1 and ready for the in-mold forming process.

The stationary base 22 has a guide hole 27, and the moving base 12 has a guide pin 17 for inserting into the guide hole 27. The insertion of the guide pin 17 provides the positioning between the stationary base 22 and the moving base 12, and therefore the two bases 12, 22 can be joined correctly and accurately.

The stationary half 20 further includes a stationary retaining plate, and the moving half 10 further includes a moving retaining plate. The embodiment of the present invention can be exemplified by each having two retaining plates. The stationary half 20 includes a first stationary retaining plate 28 and a second stationary retaining plate 29 stacked on the first one 28 and they press the workpiece to be processed respectively at different upper and lower locations. The moving half 10 includes a first moving retaining plate 18 and a second moving retaining plate 19 stacked on the first one 18 and they press the workpiece to be processed respectively at different upper and lower locations. The first and second stationary retaining plates 28 and 29 of the stationary half 20 press the workpiece to be processed from one side, and the first and second moving retaining plates 18 and 19 of the moving half 10 press the workpiece to be processed from the opposite side. The workpiece can therefore be retained by being pressed from both sides. In the present embodiment, the first moving retaining plate 18, the second moving retaining plate 19, the first stationary retaining plate 28, and the second stationary retaining plate 29 respectively elevate beyond the parting surface of the forming mold 1, and the plates 18, 19, 28, and 29 are exemplarily made of Teflon.

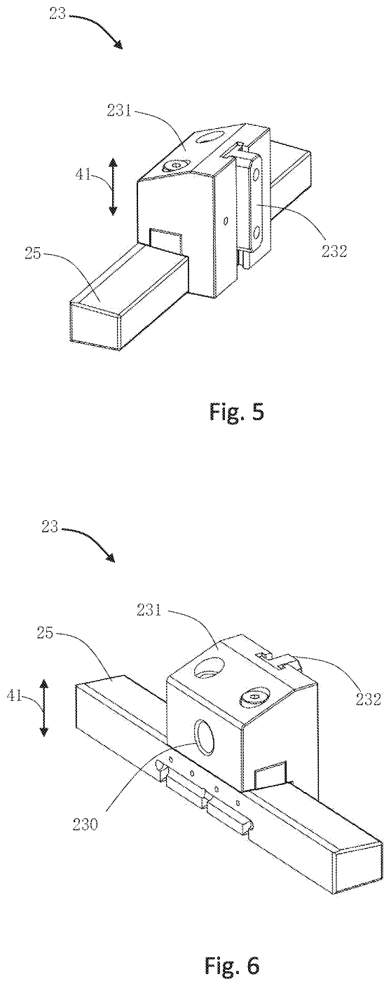

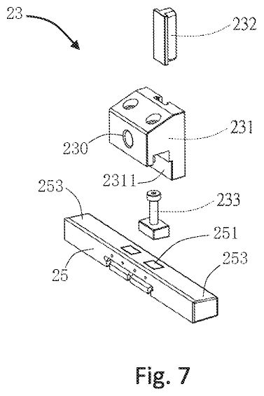

Please refer to FIGS. 5, 6, and 7. FIG. 5 is a three-dimensional schematic diagram of the slider of the forming mold of the present embodiment of the invention. FIG. 6 is a three-dimensional schematic diagram of the slider from another view angle. FIG. 7 is a three-dimensional exploded view of the folding mold. In the forming mold of the present embodiment, the slider 23 includes a slider base 231 which is slidable relative to a guide track 232 in the vertical direction 41. The guide track 232 is fixed on the stationary base 22 and is inserted into the slider base 231.

In the forming mold of the present embodiment, the slider base 231 has a recess 2311 which is complementary to the movable traverse bar 25 for receiving the movable traverse bar 25. The slider base 231 and the movable traverse bar 25 each has an inclined surface that matches with each other, so the movable travers bar 25 can be fitted with the slider base 231 and then fixed onto the stationary base 22. The movable traverse bar 25 is disposed on the stationary base 22 by way of being received in the slot 221 and the recess 2311 at the same time.

The movable traverse bar 25 of the forming mold 1 of the present embodiment includes a fixing element 251 disposed in the movable traverse bar 25. The space 30 is used for accommodating the workpiece to be processed. The fixing element 251 is used for receiving a part of the workpiece to be processed so as to fix the workpiece to be processed. In the present embodiment, the workpiece to be processed can be exemplified by a cable connector having a connector head, a metal casing, and a cable. Exemplarily, in the forming mold 1, the connector head is disposed in the fixing element 251, thereby being fixed in the movable traverse bar 25. When the movable traverse bar 25 is fixed on the stationary base 22, the connector head can also be fixed. The connector head can be prevented from shaking, which can improve the quality of in-mold forming.

In the forming mold 1 of the embodiment of the present invention, the movable traverse bar 25 is placed in the horizontal direction 42 and the movable traverse bar 25 has an access portion 253 at each end thereof. The access portions 253 project from the stationary base 22 for facilitating the operation of placing and removing the workpiece to be processed and the movable traverse bar 25.

The slider base 231 has a guide cavity 230. The inclined guide pillar 15 is inserted into the guide cavity 230, so the slider base 231 can cooperate with the inclined guide pillar 15 to achieve the function of moving the slider base 231.

The slider 23 further includes a pressing piece 233 disposed in the slider base 231. One end of the pressing piece 233 is used for pressing against the movable traverse bar 25. The pressing piece 233 is used for adjusting the distance between the movable traverse bar 25 and the slider base 231, and the adjustment of the vertical location of the movable traverse bar 25 in the vertical direction can be realized.

The forming mold according to the above embodiments of the present invention includes the stationary half and the moving half. The stationary half includes the stationary plate, the stationary base fixed on the stationary plate, and the slider and the movable traverse bar that are disposed on the stationary base. The slider and the movable traverse bar are movable on the stationary base in the vertical direction. The moving half matches with the stationary half. The moving half is movable relative to the stationary half in the horizontal direction. The space for in-mold forming is created between the stationary half and the moving half. Since the slider and the movable traverse bar of the forming mold of the present invention are movable on the stationary base in the vertical direction, the forming mold can adapt to different workpieces of different sizes, thus increasing the flexibility of utilizing the forming mold. By utilizing the same forming mold to adapt to different sizes of workpieces, the problems like burrs or interferences of in-mold forming process can be prevented, and the quality of the in-mold forming can be improved. Since the same forming mold can adapt to different sizes of workpieces, it is not required to replace the whole forming mold in accordance with the workpieces, the cost can be saved.

Although the preferred embodiments have been disclosed, they are not intended to limit the invention. Those skilled in the related art can make some alternations or modifications, without departing from the scope of the technical solutions of the invention, to achieve equivalent embodiments by using the above-disclosed technical contents. Yet any simple modifications, equivalent changes and modifications made to the above-mentioned embodiments, without departing from the content of the technical solutions of the invention, still fall within the scope of the technical solutions of the present invention.

1. A forming mold comprising:
a stationary half comprising:
a stationary plate;
a stationary base fixed on the stationary plate; and
a slider and a movable traverse bar which are disposed on the stationary base, wherein the slider and the movable traverse bar are movable on the stationary base in a vertical direction; and
a moving half matched with the stationary half, wherein the moving half is movable relative to the stationary half in a horizontal direction, and a space for in-mold forming is created between the stationary half and the moving half.

2. The forming mold according to claim 1, wherein the slider comprises a slider base which is slidable relative to a guide track in the vertical direction, the guide track is fixed on the stationary base and is inserted into the slider base.

3. The forming mold according to claim 2, wherein the slider base has a recess which is complementary to the movable traverse bar for receiving the movable traverse bar.

4. The forming mold according to claim 3, wherein the stationary base has a slot, the size of the slot in the vertical direction is larger than that of the movable traverse bar, the movable traverse bar is received in the slot and is movable in the slot.

5. The forming mold according to claim 4, wherein the movable traverse bar is disposed on the stationary base by way of being received in the slot and the recess at the same time.

6. The forming mold according to claim 1, wherein the space is used for accommodating a workpiece to be processed, the moving half comprises a moving plate and a moving base fixed on the moving plate, when the moving base and the stationary base are joined with each other, the workpiece to be processed, the slider, and the movable traverse bar are sandwiched therebetween.

7. The forming mold according to claim 6, wherein the moving base has a shovel element and an inclined guide pillar, when the moving half moves towards the stationary half, the shovel element and the inclined guide pillar drive the slider moving towards the workpiece to be processed.

8. The forming mold according to claim 7, wherein when the stationary half is closely joined with the moving half, the slider abuts against the movable traverse bar in the vertical direction and the movable traverse bar abuts against the workpiece to be processed in the vertical direction.

9. The forming mold according to claim 1, wherein the space is used for accommodating a workpiece to be processed, the movable traverse bar comprises a fixing element disposed in the movable traverse bar for receiving a part of the workpiece to be processed so as to fix the workpiece to be processed.

10. The forming mold according to claim 9, wherein the movable traverse bar is placed in the horizontal direction and has an access portion at each end projecting from the stationary base for placing or removing the workpiece to be processed and the movable traverse bar.
